(19) United States
(12) Patent Application Publication
(10) Pub. No.: US 2018/0059469 A1
(43) Pub. Date: Mar. 1, 2018

(54) DISPLAY DEVICE

(71) Applicant: Samsung Display Co. Ltd., Yongin-si (KR)

(72) Inventors: Jang Il KIM, Asan-si (KR); Keun Woo PARK, Incheon (KR); Su Wan WOO, Suwon-si (KR); Yeo Geon YOON, Suwon-si (KR); Hee Keun LEE, Suwon-si (KR)

(21) Appl. No.: 15/684,182

(22) Filed: Aug. 23, 2017

(30) Foreign Application Priority Data
Aug. 23, 2016 (KR) 10-2016-0106915

(51) Int. Cl. G02F 1/1333; G02F 1/1335; G02B 1/14

(52) U.S. Cl. CPC G02F 1/133377; G02B 1/14; G02F 1/133305; G02F 1/133528

(57) ABSTRACT

A curved display device may include a first substrate on which a plurality of scan lines are disposed to extend in a first direction; a first pixel unit disposed over the scan lines and including first, second and third sub-pixel electrodes, which are adjacent to one another in a second direction that is different from the first direction; a second substrate facing the first substrate; and a color conversion layer disposed on the second substrate and including first and second wavelength conversion layers, which overlap with the first and second sub-pixel electrodes, respectively.

Each of the first, second and third sub-pixel electrodes may have long sides, which extend in the first direction, and short sides, which extend in the second direction, and each of the first and second wavelength conversion layers may include wavelength conversion materials.

This application claims priority to and the benefit of Korean Patent Application No. 10-2016-0106915, filed on Aug. 23, 2016; the Korean Patent Application is incorporated by reference herein.

### BACKGROUND

### 1. Field

The technical field relates to a display device, e.g., a curved display device.

### 2. Description of the Related Art

A flat panel display device may have satisfactory energy efficiency. When a viewer views a flat panel display device, distances from the viewer to different areas of the display screen of the flat panel display device vary.

A curved display device may also have satisfactory energy efficiency. When a viewer views a curved display device, distances from the viewer to the center area and side areas of the curved display device may have minimum variations. Therefore, a curved display device may provide enhanced viewer experience.

### SUMMARY

Embodiments may be related to a display device, e.g., a curved display device, capable of optimizing mixing of colors between adjacent pixel units.

Embodiments may be related to a display device, e.g., a curved display device, capable of securing a sufficient driving margin and/or attaining a satisfactory aperture ratio. According to an embodiment, a curved display device may include a first substrate on which a plurality of scan lines are disposed to extend in a first direction; a first pixel unit disposed over the scan lines and including first, second and third sub-pixel electrodes, which are adjacent to one another in a second direction that is different from the first direction; a second substrate facing the first substrate; and a color conversion layer disposed on the second substrate and including first and second wavelength conversion layers, which overlap with the first and second sub-pixel electrodes, respectively.

Each of the first, second and third sub-pixel electrodes may have long sides, which extend in the first direction, and short sides, which extend in the second direction, and each of the first and second wavelength conversion layers may include wavelength conversion materials.

According to an embodiment, a curved display device may include a first substrate; a second substrate facing the first substrate; a first sub-pixel region including a first sub-pixel electrode, which is disposed on the second substrate, and a first wavelength conversion layer, which is disposed on the first substrate and overlaps with the first sub-pixel electrode; a second sub-pixel region including a second sub-pixel electrode, which is disposed in the same layer as the first sub-pixel electrode, and a second wavelength conversion layer, which is disposed on the second substrate and overlaps with the second sub-pixel electrode; and a third sub-pixel region including a third sub-pixel electrode, which is disposed in the same layer as the first sub-pixel electrode, and a transmissive layer, which is disposed on the second substrate and overlaps with the third sub-pixel electrode.

Each of the first, second and third sub-pixel electrodes may have long sides, which extend in a first direction, and short sides, which extend in a second direction that intersects the first direction, the first, second and third sub-pixel electrodes may be adjacent to one another in the second direction, and each of the first and second wavelength conversion layers may include wavelength conversion materials.

According to embodiments, a display device may optimize mixing of colors.

In embodiments, a sufficient driving margin may be secured, and a satisfactory aperture ratio may be attained.

### BRIEF DESCRIPTION OF THE DRAWINGS

FIG. 1 is a perspective view of a display device, e.g., a curved display device, according to an embodiment.

FIG. 2 is an exploded perspective view of a display device, e.g., a curved display device, according to an embodiment.

FIG. 3 is a cross-sectional view taken along line I-I′ of FIG. 2 according to an embodiment.

FIG. 4 is a circuit diagram illustrating a first sub-pixel unit illustrated in FIG. 2 according to an embodiment.

FIG. 5 is a schematic view illustrating a part of a display panel of a display device, e.g., a curved display device, according to an embodiment.

FIG. 6, FIG. 7, FIG. 8, FIG. 9, and FIG. 10 are schematic views illustrating parts of one or more display panels of one or more display devices, e.g., one or more curved display devices, according to one or more embodiments.

FIG. 11 is a cross-sectional view of a display device, e.g., a curved display device, according to an embodiment.

### DETAILED DESCRIPTION

Example embodiments are described with reference to the drawings. Various embodiments may be practiced.

In the accompanying figures, sizes and/or relative sizes of layers, films, panels, regions, etc., may be exaggerated for clarity and descriptive purposes. Like reference numerals may denote like elements.

Although the terms “first”, “second”, etc. may be used herein to describe various elements, these elements, should not be limited by these terms. These terms may be used to distinguish one element from another element. Thus, a first element discussed below may be termed a second element without departing from teachings of one or more embodiments. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

When a first element is referred to as being “on,” “connected to,” or “coupled to” a second element, the first element may be directly on, directly connected to, or directly coupled to the second element, or one or more intervening elements may be present. When a first element is referred to as being “directly on,” “directly connected to,” or “directly coupled to” a second element, there are no intended intervening elements (except environmental elements such as air) present between the first element and the second element.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various embodiments are described herein with reference to sectional illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes may not perfectly illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

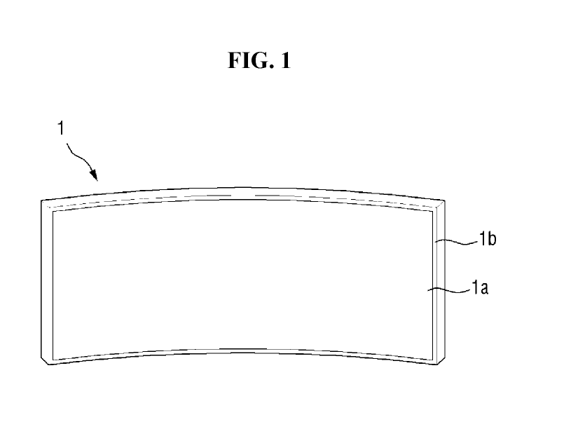

FIG. 1 is a schematic perspective view of a display device, e.g., a curved display device, according to an embodiment.

Referring to FIG. 1, the curved display device may include a display panel 1, which has a display surface 1a and a bezel area 1b.

The display surface 1a of the display panel 1 may display an image according to received data. The bezel area 1b may be defined as an area where no dynamic image is displayed. The bezel area 1b may be disposed on the outside of the display surface 1a and may protect the display surface 1a and the inner parts of the curved display device.

The display panel 1 may be bent to have a predetermined curvature. Assuming that the center of a circle obtained by extending the curved surface of the display panel 1 coincides with the location of a viewer's eye, the distance from the viewer's eye to the display surface 1a may be generally uniform. Accordingly, the curved display device may provide an improved sense of immersion to the viewer who watches the display surface 1a.

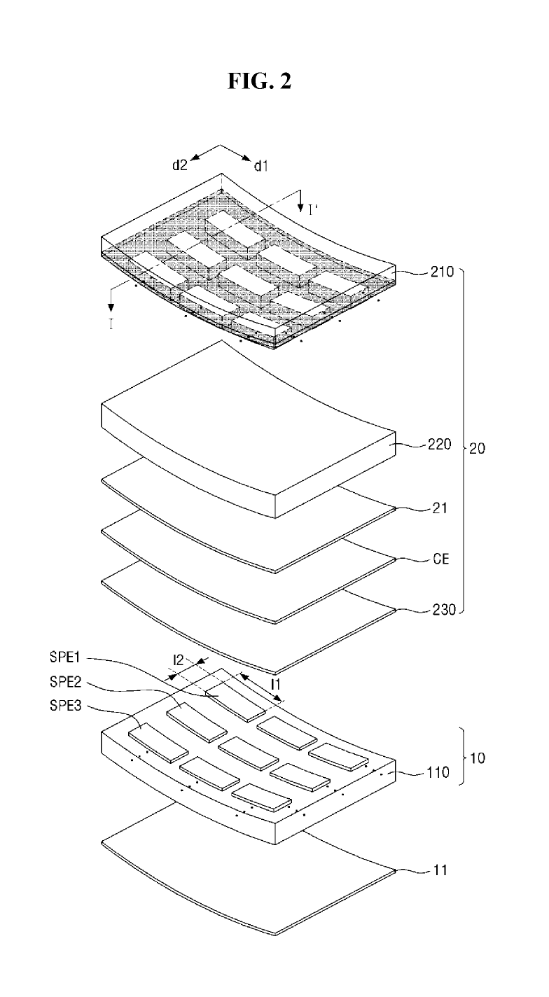

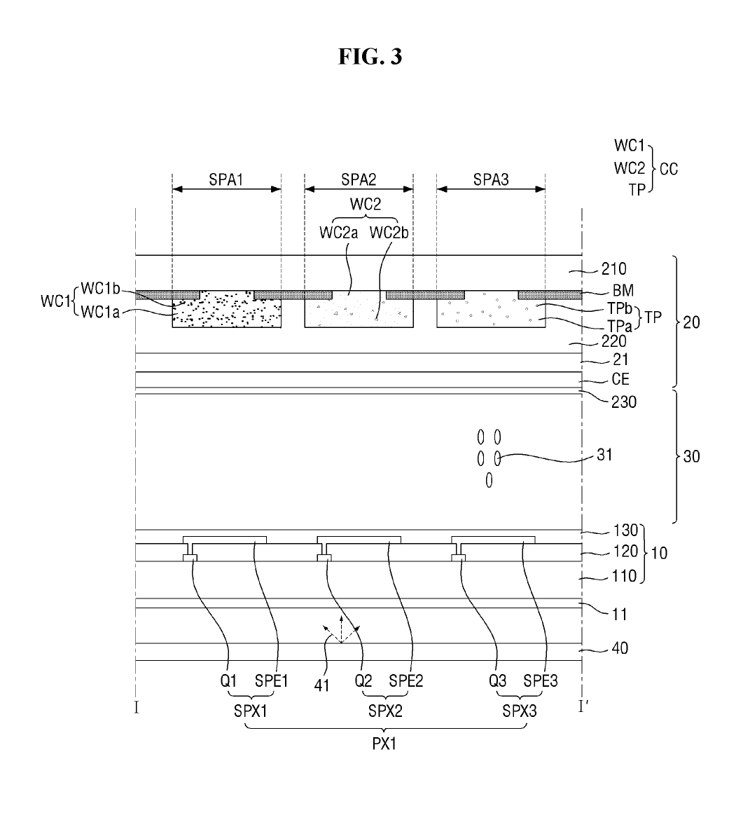

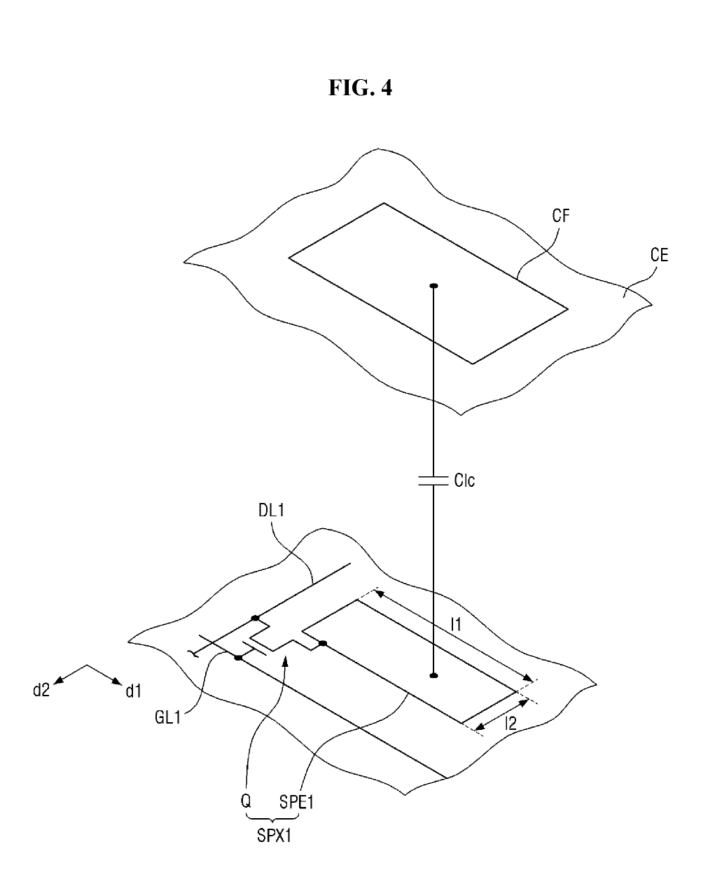

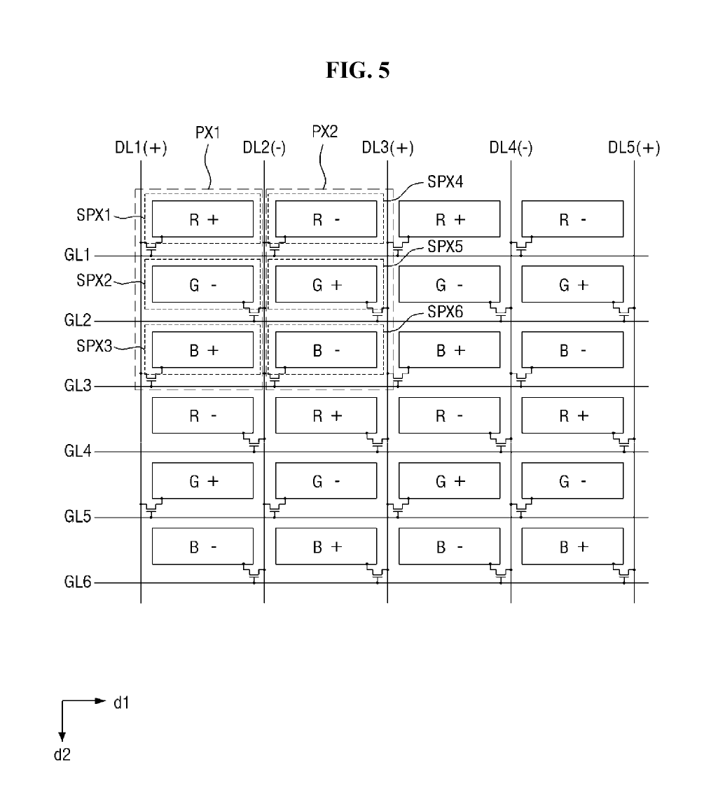

FIG. 2 is an exploded perspective view of the curved display device according to an embodiment. FIG. 3 is a cross-sectional view taken along line I-I′ of FIG. 2 according to an embodiment. FIG. 4 is a circuit diagram illustrating a first sub-pixel unit illustrated in FIG. 2 according to an embodiment.

Referring to FIGS. 1, 2, and 3, the curved display device may include the display panel 1 and a backlight unit 40.

The display panel 1 may include a lower display panel 10, an upper display panel 20, and a liquid crystal layer 30, which is interposed between the lower display panel 10 and the upper display panel 20.

The lower display panel 10 may face the upper display panel 20. The liquid crystal layer 30 may be interposed between the lower display panel 10 and the upper display panel 20 and may include a plurality of liquid crystal molecules 31. For example, the lower display panel 10 may be bonded to the upper display panel 20 via sealing.

The lower display panel 10 will hereinafter be described.

For example, a lower substrate 110 may be a transparent insulating substrate. Examples of the transparent insulating substrate include a glass substrate, a quartz substrate, and a transparent resin substrate.

A first polarizer 11 may be disposed at the bottom of the lower substrate 110, as illustrated in FIG. 3. The first polarizer 11 may be formed of an organic material or an inorganic material. For example, the first polarizer 11 may be a reflective polarizer. In a case in which the first polarizer 11 is a reflective polarizer, the first polarizer 11 may allow the transmission of components polarized in parallel to its transmission axis and may reflect components polarized in parallel to its reflection axis.

In an embodiment, the first polarizer 11 may be disposed on the lower substrate 110. That is, the first polarizer 11 may be disposed between the lower substrate 110 and first through third switching elements Q1, Q2, and Q3 that will be described later.

A first pixel unit PX1 may include first, second, and third sub-pixel units SPX1, SPX2, and SPX3.

The first through third sub-pixel units SPX1, SPX2, and SPX3 may extend in a first direction d1 in a plan view of the display device and may include first through third sub-pixel electrodes SPE1, SPE2, and SPE3, respectively, which are disposed adjacent to one another. The expression “first and second elements adjacent to each other,” as used herein, may indicate that there is no intervening element, which is of the same kind as the first and second elements, disposed between the first and second elements.

The first sub-pixel unit SPX1 may include the first switching element Q1 and the first sub-pixel electrode SPE1. The second sub-pixel unit SPX2 may include the second switching element Q2 and the second sub-pixel electrode SPE2. The third sub-pixel unit SPX3 may include the third switching element Q3 and the third sub-pixel electrode SPE3.

The first switching element Q1 will hereinafter be described with reference to FIG. 4. FIG. 4 illustrates the first switching element Q1 as being electrically connected to a first scan line GL1 and a first data line DL1.

For example, the first switching element Q1 may be a three-terminal element such as a thin-film transistor (TFT). In an embodiment, the first through third switching elements Q1 through Q3 are TFTs.

The gate electrode of the first switching element Q1 may be connected to the first scan line GL1, and the source electrode of the first switching element Q1 may be connected to the first data line DL1. For example, the first scan line GL1 may extend in the first direction d1 in a plan view of the display device. For example, the first data line DL1 may extend in a second direction d2, which is different from the first direction d1. For example, the first direction d1 may intersect the second direction d2. Referring to FIG. 4, the first direction d1 may be a row direction, and the second direction d2 may be a column direction.

The drain electrode of the first switching element Q1 may be connected to the first sub-pixel electrode SPE1. Accordingly, the first switching element Q1 may be turned on by a scan signal provided thereto via the first scan line GL1 and may thus provide a data signal provided thereto via the first data line DL1 to the first sub-pixel electrode SPE1.

In an embodiment, one sub-pixel unit includes one switching element. In an embodiment, one sub-pixel unit may include two or more switching elements.

An insulating layer 120 may be disposed on the first through third switching elements Q1 through Q3. For example, the insulating layer 120 may be formed of an inorganic insulating material such as silicon oxide.

In an embodiment, the insulating layer 120 may be formed of an organic insulating material. That is, the insulating layer 120 may comprise an organic material having excellent planarization properties and photosensitivity.

The first through third sub-pixel electrodes SPE1 through SPE3 may be disposed on the insulating layer 120. For example, the first through third sub-pixel electrodes SPE1 through SPE3 may be formed of a transparent conductive material such as indium tin oxide (ITO) or indium zinc oxide (IZO) or a reflective metal such as aluminum (Al), silver (Ag), chromium (Cr), or an alloy.

The first sub-pixel electrode SPE1 will hereinafter be described with reference to FIG. 4. The first sub-pixel electrode SPE1 may be capacitively coupled to a common electrode CE. The first sub-pixel electrode SPE1 may overlap with the common electrode CE in a vertical direction with respect to the lower substrate 110. The expression “two electrodes overlapping with each other,” as used herein, may denote that the two electrodes are disposed adjacent to each other and may thus be capacitively coupled to each other. Also, the expression “two electrodes overlapping with each other,” as used herein, may mean that the two electrodes overlap each other in the vertical direction with respect to a bottom face of the lower substrate 110.

Since the first sub-pixel electrode SPE1 and the common electrode CE may overlap with each other, the first sub-pixel unit SPX1 may further include a liquid crystal capacitor Clc, which is formed between the first sub-pixel electrode SPE1 and the common electrode CE. Although not specifically illustrated, the first sub-pixel unit SPX1 may further include a storage capacitor, which is formed between the first sub-pixel electrode SPE1 and a storage line (not illustrated).

The first sub-pixel electrode SPE1 may have long sides I1, which extend in the first direction d1, and short sides I2, which extend in the second direction d2. The long sides I1 of the first sub-pixel electrode SPE1 may be longer than the short sides I2 of the first sub-pixel electrode SPE1. Since the long sides I1 may be longer than the short sides I2, the mixing of colors in the curved display device may be improved. The size and shape of the first sub-pixel electrode SPE1 are not particularly limited to those illustrated in FIGS. 2 through 4 as long as the long sides I1 are longer than the short sides I2.

The first sub-pixel electrode SPE1 may overlap with a first wavelength conversion layer WC1. The second sub-pixel electrode SPE2 may overlap with a second wavelength conversion layer WC2. The third sub-pixel electrode SPE1 may overlap with a transmissive layer TP.

A lower alignment layer 130 may be disposed on the first through third sub-pixel electrodes SPE1 through SPE3. The lower alignment layer 130 may be formed of polyimide (PI).

The upper display panel 20 will hereinafter be described.

An upper substrate 210 may face the lower substrate 110. The upper substrate 210 may be formed of transparent glass or plastic. For example, the upper substrate 210 may be formed of the same material as the lower substrate 110.

Black matrices BM, which block the transmission of light in a region other than a pixel region, may be disposed on the upper substrate 210. For example, the black matrices BM may be formed of an organic material or a metal material comprising Cr.

A color conversion layer CC may be disposed on the black matrices BM. The color conversion layer CC may include the first wavelength conversion layer WC1, the second wavelength conversion layer WC2, and the transmissive layer TP.

The first wavelength conversion layer WC1 may overlap with the first sub-pixel electrode SPE1 in the vertical direction with respect to the lower substrate 110. Accordingly, a first sub-pixel region SPA1, which displays a first color, may be formed.

For example, the first wavelength conversion layer WC1 may include a first light-transmitting resin WC1a and a first wavelength conversion material WC1b, which is distributed in the first light-transmitting resin WC1a and converts or shifts light 41 having a wavelength in a first wavelength range, provided by the backlight unit 40, into light having a wavelength in a second wavelength range. The first color displayed by the first sub-pixel region SPA1 may be in the second wavelength range.

The second wavelength conversion layer WC2 may overlap with the second sub-pixel electrode SPE2 in the vertical direction with respect to the lower substrate 110. Accordingly, a second sub-pixel region SPA2, which displays a second color, may be formed.

For example, the second wavelength conversion layer WC2 may include a second light-transmitting resin WC2a and a second wavelength conversion material WC2b, which is distributed in the second light-transmitting resin WC2a and converts or shifts the light 41 provided by the backlight unit 40 into light having a wavelength in a third wavelength range. The second color displayed by the second sub-pixel region SPA2 may be in the third wavelength range.

The transmissive layer TP may include a third light-transmitting resin TPa and a light-scattering material TPb, which is distributed in the third light-transmitting resin TPa and scatters and emits incident light.

The transmissive layer TP may overlap with the third sub-pixel electrode SPE3 in the vertical direction with respect to the lower substrate 110. Accordingly, a third sub-pixel region SPA3, which displays a third color according to the light 41, may be formed.

The first, second, and third light-transmitting resins WC1a, WC2a, and TPa may comprise a transparent material transmitting incident light without converting the wavelength of the incident light. The first, second, and third light-transmitting resins WC1a, WC2a, and TPa may comprise the same material or different materials.

The first through third colors may be different from one another. For example, the color of the light 41 in the first wavelength range, i.e., the third color, may be blue, the color of the light in the second wavelength range, i.e., the first color, may be red, and the color of the light in the third wavelength range, i.e., the second color, may be green.

The first and second wavelength conversion materials WC1b and WC2b may comprise quantum dots, quantum rods, and/or a phosphor material. The first and second wavelength conversion materials WC1b and WC2b may absorb incident light and may emit light having a different central wavelength from the incident light.

The first and second wavelength conversion materials WC1b and WC2b may scatter light incident upon the first and second sub-pixel regions SPA1 and SPA2, respectively, in various directions regardless of the incidence angle of the light and may emit the scattered light. The scattered light emitted by the first and second wavelength conversion materials WC1b and WC2b may be depolarized and may be in an unpolarized state. The term “unpolarized light,” as used herein, may denote multidirectional light consisting not only of components polarized in a particular direction. That is, the term “unpolarized light,” as used herein, may denote light consisting of randomly polarized components. Examples of unpolarized light include natural light.

The first wavelength conversion material WC1b, which converts the central wavelength of incident light into a red wavelength, may have a larger average particle size than the second wavelength conversion material WC2b, which converts the central wavelength of incident light into a green wavelength. The first and second wavelength conversion materials WC1b and WC2b may comprise the same material or different materials.

The light-scattering material TPb may scatter light incident upon the third sub-pixel region SPA3 in various directions regardless of the incidence angle of the light and may emit the scattered light. The scattered light emitted by the light-scattering material TPb may be depolarized and may be in an unpolarized state. The curved display device may provide light transmitted through the third sub-pixel region SPA3 or the third pixel PXb as scattered light and may thus allow light emitted from each sub-pixel region to have similar properties.

The light-scattering material TPb may have a different refractive index from the third light-transmitting resin TPa. For example, the light-scattering material TPb may comprise white or colorless organic or inorganic particles, organic/inorganic hybrid particles, or particles having a hollow structure. Examples of the organic particles include acrylic resin particles or urethane resin particles, and examples of the inorganic particles include metal oxide particles such as titanium oxide particles.

In an example, at least one of the first wavelength conversion layer WC1, the second wavelength conversion layer WC2, and the transmissive layer TP may not be provided. The arrangement of the first wavelength conversion layer WC1, the second wavelength conversion layer WC2, and the transmissive layer TP is not particularly limited to that illustrated in FIGS. 2 and 3.

A planarization layer 220 may be disposed on the color conversion layer CC. For example, the planarization layer 220 may be formed of an organic material. In a case in which the first wavelength conversion layer WC1, the second wavelength conversion layer WC2, and the transmissive layer TP have different thicknesses from one another, the planarization layer 240 may make the heights of components stacked on one surface of the upper substrate 210 uniform.

The planarization layer 220, which contacts the color conversion layer CC, is illustrated in FIG. 2 as having a uniform surface height. In an embodiment, the surface height of the planarization layer 220 may vary depending on the height of the color conversion layer CC and the height of the black matrices BM.

A second polarizer 21 may be disposed on the planarization layer 220. For example, the second polarizer 21 may be formed on a rubbed surface of the planarization layer 220. Since the second polarizer 21 may be disposed between the lower substrate 110 and the upper substrate 210, the second polarizer 21 may be prevented from being deformed by moisture or heat, and the manufacturing cost of the second polarizer 21 may be reduced.

A common electrode CE may be disposed on the second polarizer 21. The common electrode CE may at least partially overlap with the first through third sub-pixel electrodes SPE1 through SPE3 For example, the common electrode CE may be in the form of a plate. For example, the common electrode CE may be formed of a transparent conductive material such as ITO or IZO or a reflective metal such as Al, Ag, Cr, or an alloy thereof.

An upper alignment layer 230 may be disposed on the common electrode CE. The upper alignment layer 230 may be formed of PI.

The liquid crystal layer 30 will hereinafter be described.

The liquid crystal layer 30 includes the liquid crystal molecules 31, which have dielectric anisotropy and refractive anisotropy. The liquid crystal molecules 31 may be aligned in the vertical direction with respect to the lower substrate 110 in the absence of an electric field in the liquid crystal layer 30. On the other hand, in the presence of an electric field between the lower substrate 110 and the upper substrate 210, the liquid crystal molecules 31 may be rotated or tilted in a particular direction so as to change the polarization of light.

The backlight unit 40 may include a light source, an optical member, and a reflective member. A light-emitting diode (LED) light source, an organic light-emitting diode (OLED) light source, or a fluorescent lamp light source may be used as the light source. The light source may emit light having a particular wavelength toward the display panel 1. For example, the light source may provide the light 41 in the first wavelength range to the display panel 1. The first wavelength range may have a single central wavelength shorter than the central wavelength of a red wavelength range and the central wavelength of a green wavelength range. In an embodiment, the light source may provide blue light having a central wavelength of about 400 nm to about 500 nm.

Although not specifically illustrated, in an embodiment, the light source may provide ultraviolet (UV) light. In this example, a third wavelength conversion material capable of converting the central wavelength of incident light into a visible-color wavelength (e.g., blue wavelength), instead of a light-scattering material, may be provided in a pixel displaying a blue color.

An optical member may be disposed between the light source and the display panel 1. The optical member may include a diffusion sheet, a prism sheet, a lens sheet, and the like and may modulate the characteristics and the path of light provided by the light source. For example, the optical member may not be provided. The reflective member may be disposed below the light source. The reflective member may reflect light emitted downwardly from the light source or light reflected from the first polarizer 11 and may thus provide the light back to the display panel 1. Accordingly, the optical efficiency of the curved display device may be improved.

FIG. 5 is a schematic view illustrating a part of the display panel 1 of the curved display device according to an embodiment. A plurality of scan lines may extend in the first direction d1 in a plan view of the display device and may include, for example, first through sixth scan lines GL1, GL2, GL3, GL4, GL5, and GL6, which are adjacent to one another. A plurality of data lines may extend in the second direction d2 and may include, for example, first through fifth scan lines DL1, DL2, DL3, DL4, and DL5, which are adjacent to one another. A plurality of pixel units may include first and second pixel units PX1 and PX2, for example. Referring to FIG. 5, reference characters “R”, “G”, and “B” represent sub-pixel units displaying a red color, sub-pixel units displaying a green color, and sub-pixel units displaying a blue color, respectively, and reference symbols “+” and “−” indicate sub-pixel units receiving a positive data signal during a k-th frame (where k is a natural number equal to or greater than 1) and sub-pixel units receiving a negative data signal during the k-th frame, respectively.

FIG. 5 illustrates the polarity of a data signal provided to each of the first through fifth data lines DL1 through DL5 during the k-th frame, and the polarity of a data signal provided to each of the first through fifth data lines DL1 through DL5 during a (k+1)-th frame may be obtained by reversing the polarity of the data signal provided to each of the first through fifth data lines DL1 through DL5 during the k-th frame. The polarity of a data signal may be reversed at every data line. More specifically, for example, if the polarity of the data signal provided to each of the first through fifth data lines DL1 through DL5 during the k-th frame is as illustrated in FIG. 5, the polarity of the data signal provided to each of the first through fifth data lines DL1 through DL5 during the (k+1)-th frame may be as follows: “−”, “+”, “−”, “+”, and “−”.

Sub-pixel units displaying the same color may be arranged in the same row in the first direction d1. Accordingly, red, green, and blue colors may alternately appear in the second direction d2. The width of sub-pixel units in the first direction d1, i.e., a horizontal width, may be larger than the width of sub-pixel units in the second direction d2, i.e., a vertical width. For example, sub-pixel units may have a horizontal width-to-vertical width ratio of about 2:1 to about 3:1.

Accordingly, the curved display device may optimize mixing of colors even when the display panel 1 is bent to have a predetermined curvature.

The first pixel unit PX1 may include first through third sub-pixel units SPX1 through SPX3. The first through third sub-pixel units SPX1 through SPX3 may be disposed adjacent to one another in the second direction d2. The first through third sub-pixel units SPX1 through SPX3 may be electrically connected to different scan lines.

More specifically, as illustrated in FIG. 5, the first through third sub-pixel units SPX1 through SPX3 may be electrically connected to the first through third scan lines GL1 through GL3, respectively. The first through third sub-pixel units SPX1 through SPX3 may display different colors from one another. That is, the first pixel unit PX1 may include the first through third sub-pixel units SPX1 through SPX3, which display different colors from one another and are electrically connected to different scan lines.

The first and third sub-pixel units SPX1 and SPX3 may be electrically connected to the first data line DL1. On the other hand, the second sub-pixel unit SPX2 may be electrically connected to the second data line DL2. Accordingly, the first and third sub-pixel units SPX1 and SPX3 may be provided with a positive data signal during the k-th frame, and the second sub-pixel unit SPX2 may be provided with a negative data signal during the k-th frame.

The second pixel unit PX2 may include fourth through fifth sub-pixel units SPX4 through SPX6. The fourth through sixth sub-pixel units SPX4 through SPX6 may be disposed adjacent to one another in the second direction d2. The fourth through sixth sub-pixel units SPX4 through SPX6 may be electrically connected to different scan lines.

More specifically, as illustrated in FIG. 5, the fourth through sixth sub-pixel units SPX4 through SPX6 may be electrically connected to the first through third scan lines GL1 through GL3, respectively. The fourth through sixth sub-pixel units SPX4 through SPX6 may display different colors. That is, the second pixel unit PX2 may include the fourth through sixth sub-pixel units SPX4 through SPX6, which display different colors and are electrically connected to different scan lines.

The fourth and sixth sub-pixel units SPX4 and SPX6 may be electrically connected to the second data line DL2. On the other hand, the fifth sub-pixel unit SPX5 may be electrically connected to the third data line DL3. Accordingly, the fourth and sixth sub-pixel units SPX4 and SPX6 may be provided with a negative data signal during the k-th frame, and the fifth sub-pixel unit SPX5 may be provided with a positive data signal during the k-th frame.

Consequently, the polarity of a data signal provided to each of the first through sixth sub-pixel units SPX1 through SPX may vary not only in the first direction d1, but also in the second direction d2. Accordingly, the sum of the polarities of sub-pixel units displaying the same color during the k-th frame may become zero, instead of becoming positive or negative, and a horizontal crosstalk phenomenon may be prevented.

Also, since sub-pixel units are arranged such that the polarity of data signals provided to the sub-pixel units, respectively, varies along the second direction d2, any differences in luminance among the sub-pixel units may be compensated for, and as a result, a “moving vertical stripe” phenomenon in which vertical stripes appear to move in the second direction d2 during the transition from the k-th frame to the (k+1)-th frame may be prevented.

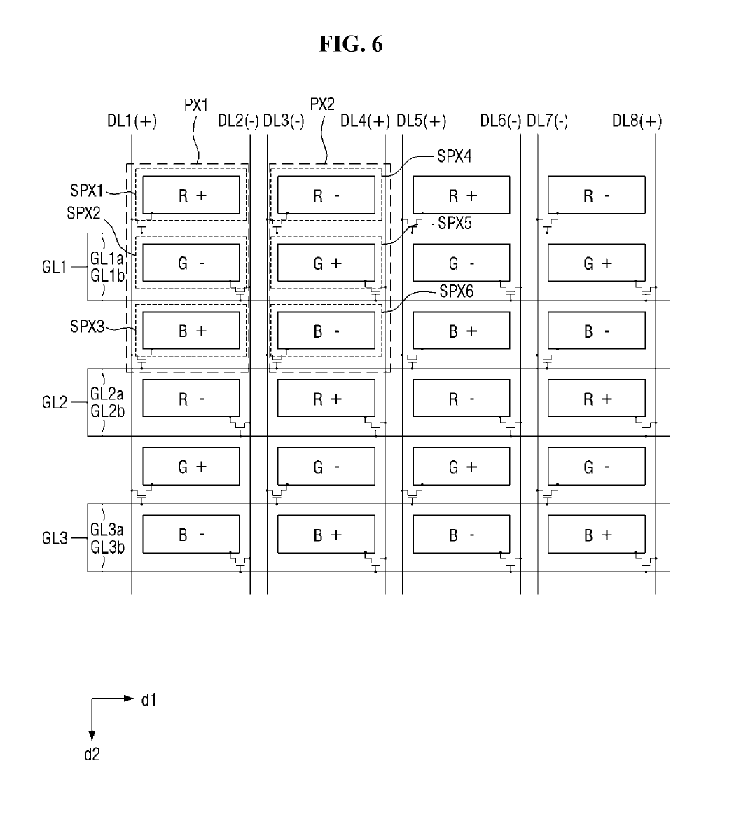

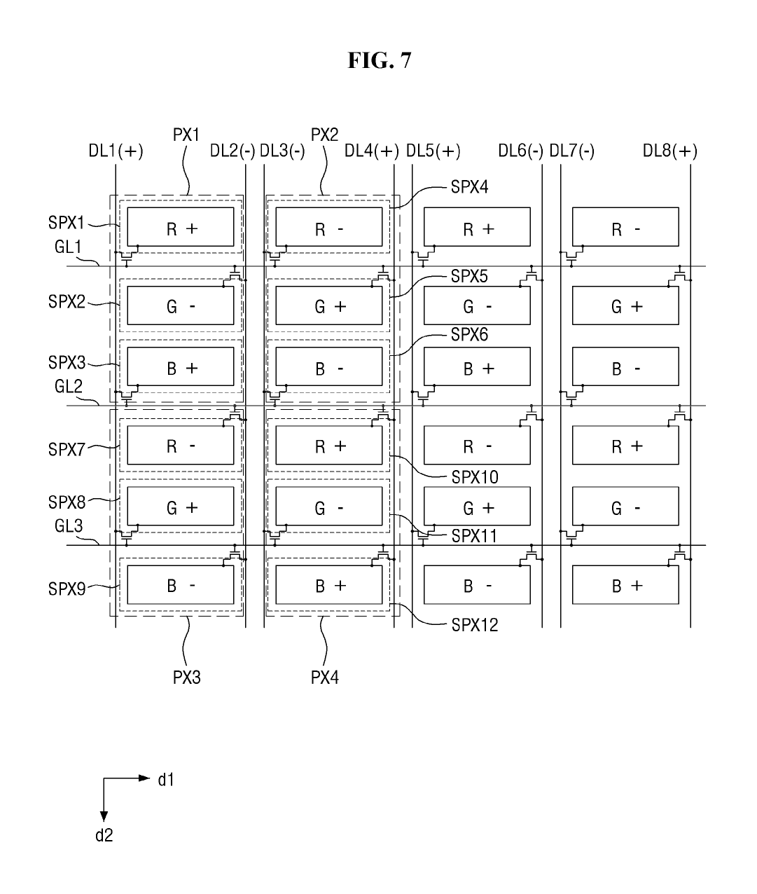

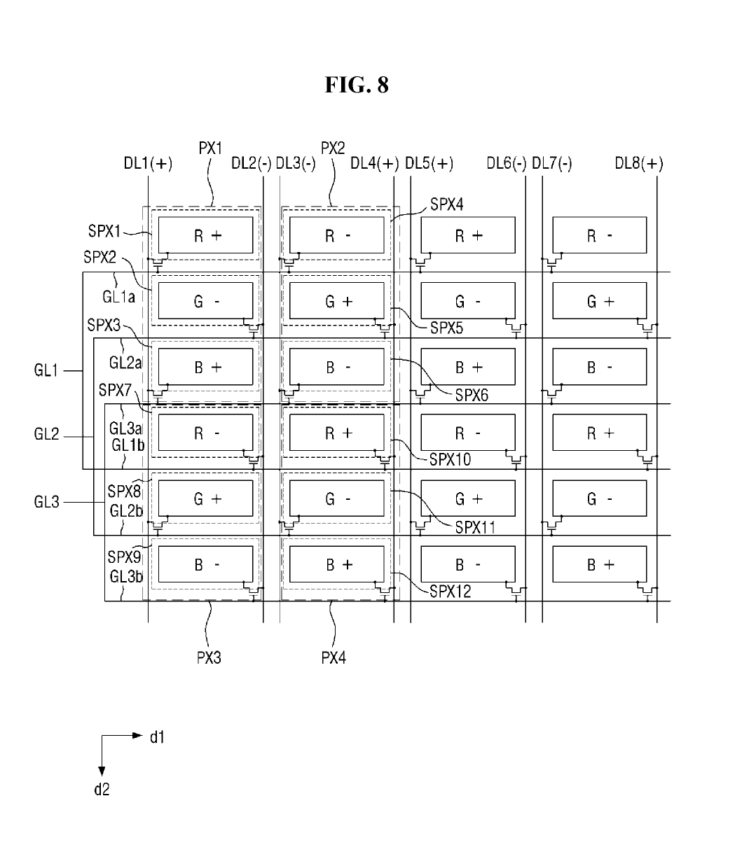

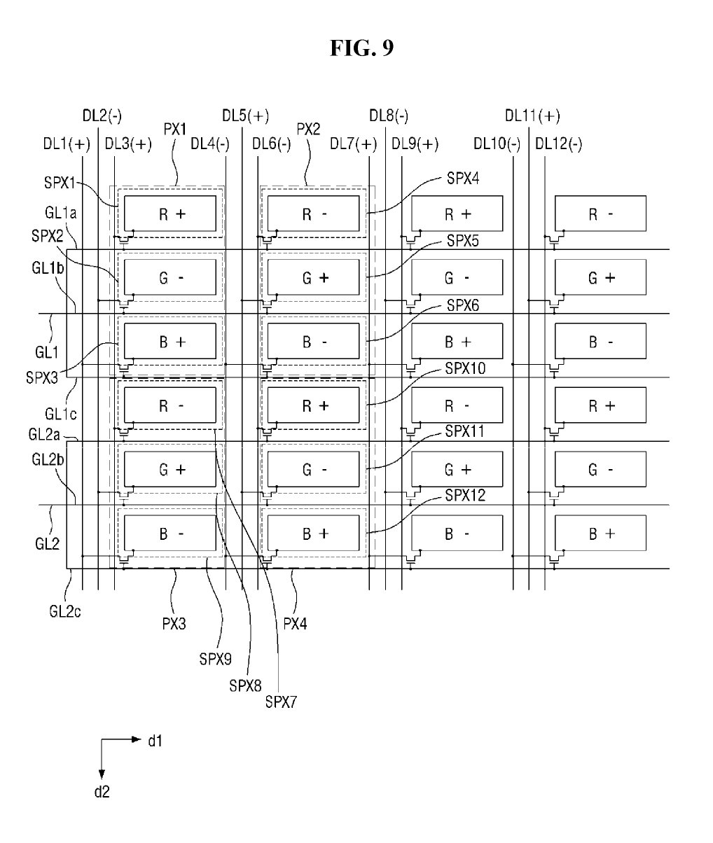

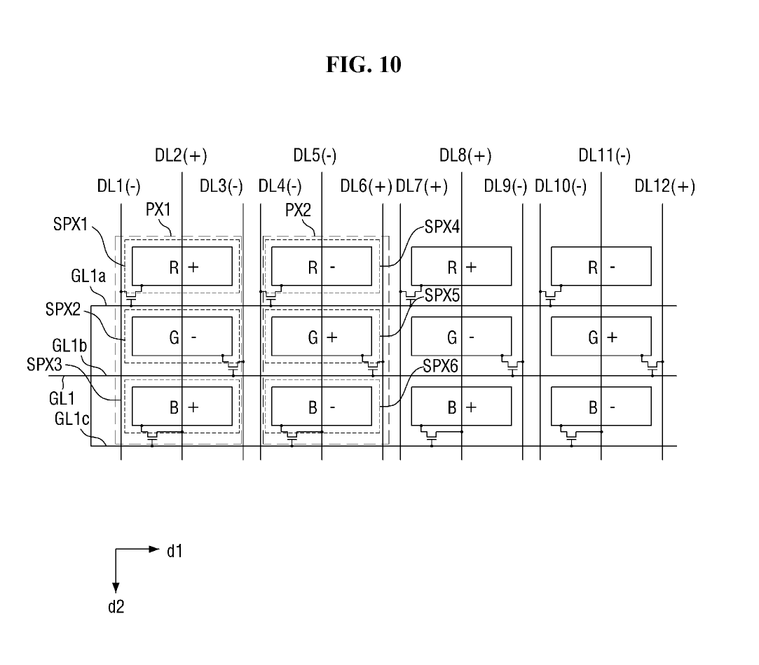

Each of FIGS. 6 through 10 is a schematic view illustrating a part the display panel 1 of the curved display device according to one or more embodiments. FIG. 6 through 10 will hereinafter be described, focusing mainly on differences from FIG. 5 and avoiding redundant descriptions. In FIGS. 5 through 10, like reference numerals may indicate like elements.

Referring to FIG. 6, a first pixel unit PX1 may be disposed between first and second data lines DL1 and DL2, which are adjacent to each other. A second pixel unit PX2 may be disposed between third and fourth data lines DL3 and DL4, which are adjacent to each other. The second and third data lines DL2 and DL3 may be adjacent to each other, and no sub-pixel unit may be disposed between the second and third data lines DL2 and DL3.

A first sub-pixel unit SPX1 may be electrically connected to a first sub-scan line GL1a. A second sub-pixel unit SPX2 may be electrically connected to a second sub-scan line GL1b. The first scan line GL1 may branch into and/or may be divided into the first and second sub-scan lines GL1a and GL1b. The first and second sub-scan lines GL1a and GL1b may be electrically connected to each other.

Thus, the first and second sub-pixel units SPX1 and SPX2 may be driven at the same time by the same scan signal. A fourth sub-pixel unit SPX4 may be electrically connected to the first sub-scan line GL1a. A fifth sub-pixel unit SPX5 may be electrically connected to the second sub-scan line GL1b. Thus, the fourth and fifth sub-pixel units SPX4 and SPX5 may be driven at the same time by the same scan signal.

That is, since each pixel unit, for example, the first pixel unit PX1, may be driven by only two scan signals provided thereto via the first scan line GL1 and a second scan line GL2, respectively, a driving margin may be increased.

The polarity of a data signal provided to each of the first sub-pixel unit SPX1, the second sub-pixel unit SPX2, a third sub-pixel unit SPX3, the fourth sub-pixel unit SPX4, the fifth sub-pixel unit SPX5, and a sixth sub-pixel unit SPX6 may vary not only in the first direction d1, but also in the second direction d2. Accordingly, the sum of the polarities of sub-pixel units displaying the same color during the k-th frame may become zero, instead of becoming positive or negative, and a horizontal crosstalk phenomenon may be prevented.

Referring to FIG. 7, each of first through fourth pixel units PX1, PX2, PX3, and PX4 may be electrically connected to two scan lines. The arrangement of, and the connections between, pixel units and gate lines will hereinafter be described, taking first and third pixel units PX1 and PX3 as an example.

The first pixel unit PX1 may include first and second sub-pixel units SPX1 and SPX2, which are electrically connected to a first scan line GL1, and a third sub-pixel unit SPX3, which is electrically connected to a second scan line GL2. That is, at least two of the first through third sub-pixel units SPX1 through SPX3 may be electrically connected to a single scan line.

The third pixel unit PX3 may be disposed adjacent to the first pixel unit PX1 in the second direction d2. The third pixel unit PX3 may include a seventh sub-pixel unit SPX7, which is electrically connected to the second scan line GL2, and eighth and ninth sub-pixel units SPX8 and SPX9, which are electrically connected to a third scan line GL3. That is, at least two of the seventh through ninth sub-pixel units SPX7 through SPX9 may be electrically connected to a single scan line.

The seventh sub-pixel unit SPX7 and the third sub-pixel unit SPX3 may be electrically connected to the same scan line, i.e., the second scan line GL2. That is, for example, every two adjacent sub-pixel units in the second direction d2 may be electrically connected to the same scan line.

As a result, since the number of scan signals that need to be provided to each pixel unit may be reduced, a driving margin may be increased. Also, since the number of scan lines connected to each pixel unit may be reduced, an aperture ratio may be optimized. Referring to FIG. 8, sub-pixel units displaying the same color may be provided with the same scan signal.

The arrangement of, and the connections among, pixel units, gate lines, and data lines will hereinafter be described, taking first and third pixel units PX1 and PX3 as an example.

The first pixel unit PX1 may include a first sub-pixel unit SPX1, which displays a red color, a second sub-pixel unit SPX2, which displays a green color, and a third sub-pixel unit SPX3, which displays a blue color. The first sub-pixel unit SPX1 may be electrically connected to a first sub-scan line GL1a, which is branched off from a first scan line GL1. The second sub-pixel unit SPX2 may be electrically connected to a third sub-scan line GL2a, which is branched off from a second scan line GL2. The third sub-pixel unit SPX3 may be electrically connected to a fifth sub-scan line GL3a, which is branched off from a third scan line GL3. That is, the first through third sub-pixel units SPX1 through SPX3, which display different colors, may be provided with different scan signals.

The third pixel unit PX3 may include a seventh sub-pixel unit SPX7, which displays a red color, an eighth sub-pixel unit SPX8, which displays a green color, and a ninth sub-pixel unit SPX9, which displays a blue color. The seventh sub-pixel unit SPX7 may be electrically connected to a second sub-scan line GL1b, which is branched off from the first scan line GL1. The eighth sub-pixel unit SPX8 may be electrically connected to a fourth sub-scan line GL2b, which is branched off from the second scan line GL2. The ninth sub-pixel unit SPX9 may be electrically connected to a sixth sub-scan line GL3b, which is branched off from the third scan line GL3. That is, the seventh through ninth sub-pixel units SPX7 through SPX9, which display different colors, may be provided with different scan signals.

The first sub-pixel unit SPX1 and the seventh sub-pixel unit SPX7 may be provided with the same scan signal. The second sub-pixel unit SPX2 and the eighth sub-pixel unit SPX8 may be provided with the same scan signal, and the third sub-pixel unit SPX3 and the ninth sub-pixel unit SPX9 may be provided with the same scan signal. That is, sub-pixel units displaying the same color may be provided with the same scan signal.

The first sub-pixel unit SPX1 may be provided with a positive data signal, and the seventh sub-pixel unit SPX7 may be provided with a negative data signal. The second sub-pixel unit SPX2 may be provided with a negative data signal, and the eighth sub-pixel unit SPX8 may be provided with a positive data signal. The third sub-pixel unit SPX3 may be provided with a positive data signal, and the ninth sub-pixel unit SPX9 may be provided with a negative data signal. That is, sub-pixel units displaying the same color may be provided with data signals having different polarities.

Accordingly, since sub-pixel units displaying the same color may be driven at the same time by being provided with the same scan signal, a color ghost defect may be improved. Also, since during a k-th frame, the number of sub-pixel units displaying a positive data signal is the same as the number of sub-pixel units displaying a negative data signal, the sum of the polarities of sub-pixel units may become zero, and thus, a phenomenon in which the sum of the polarities of sub-pixel units becomes too positive or too negative may be improved. Referring to FIG. 9, first through third sub-pixel units SPX1, SPX2, and SPX3 of a first pixel unit PX1 may be provided with the same scan signal. Similarly, sub-pixel units of each of second through fourth pixel units PX2, PX3, and PX4 may be provided with the same scan signal.

The arrangement of, and the connections among, pixel units, gate lines, and data lines will hereinafter be described, taking the first pixel unit PX1 as an example.

First through third data lines DL1 through DL3 may be disposed at a first side of the first pixel unit PX1. Fourth through sixth data lines DL4 through DL6 may be disposed at a second side of the first pixel unit PX1. The fourth through sixth data lines DL4 through DL6 may also be disposed at a first side of the second pixel unit PX2. That is, the first pixel unit PX1 may be disposed between a data line group including the first through third data lines DL1 through DL3 and a data line group including the fourth through sixth data lines DL4 through DL6.

A first sub-pixel unit SPX1 may be electrically connected to a first sub-scan line GL1a, which is branched off from a first scan line GL1. A second sub-pixel unit SPX2 may be electrically connected to a second sub-scan line GL1b, which is branched off from the first scan line GL1, and a third sub-pixel unit SPX3 may be electrically connected to a third sub-scan line GL1c, which is branched off from the first scan line GL1. As a result, since the first through third sub-scan lines GL1a through GL1c are all electrically connected, the first through third sub-pixel units SPX1 through SPX3 may all be provided with the same scan signal. Accordingly, since the first pixel unit PX1 may be driven by being provided with a single scan signal, a driving margin may be increased. Referring to FIG. 10, first through sub-pixel units SPX1, SPX2, and SPX3 of a first pixel unit PX1 may be provided with the same scan signal. Similarly, fourth through sixth sub-pixel units SPX4, SPX5, and SPX6 of a second pixel unit PX2 may be provided with the same scan signal.

The arrangement of, and the connections among, pixel units, gate lines, and data lines will hereinafter be described, taking the first pixel unit PX1 as an example.

A first data line DL1 may be disposed at a first side of the first pixel unit PX1. A third data line DL3 may be disposed at a second side of the first pixel unit PX1. A second data line DL2, which is disposed between the first and third data lines DL1 and DL3, may overlap with the first pixel unit PX1, such that the second data line DL2 may be positioned between two portions of each sub-pixel electrode of the first pixel unit PX1 in a plan view of the display device. For example, the second data line DL2 may extend in the second direction d2 to pass through the center of the first pixel unit PX1.

Accordingly, the first through third data lines DL1 through DL3 may be arranged with ease in connection with first through third sub-scan lines GL1a through GL1c. In addition, since the first pixel unit PX1 may be driven by being provided with a single scan signal, a driving margin may be increased.

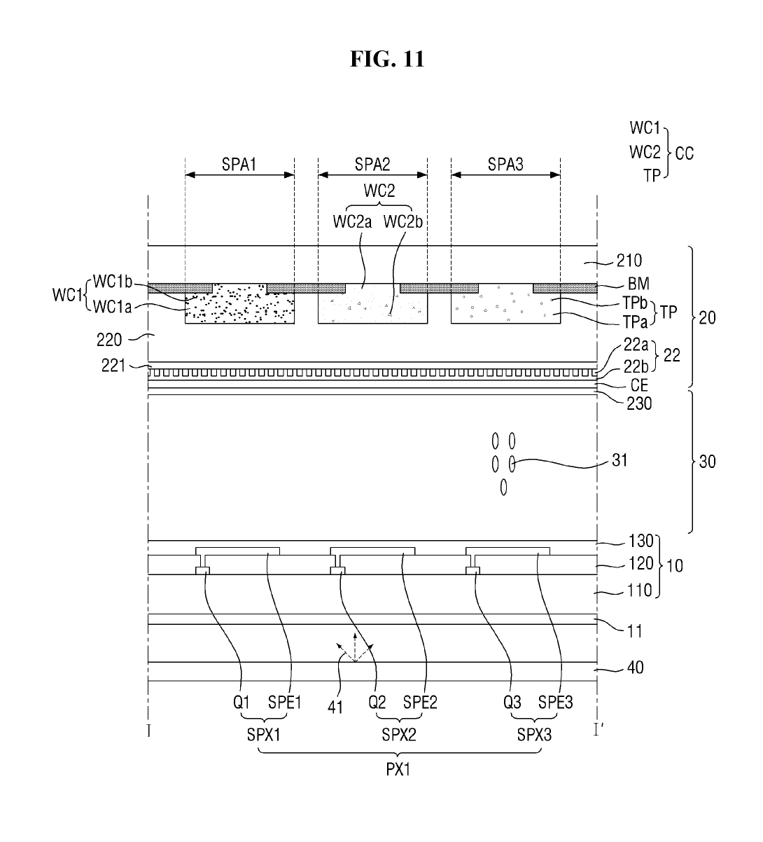

FIG. 11 is a cross-sectional view of a curved display device according to an embodiment. More specifically, FIG. 11 is a cross-sectional view, taken along line I-I′ of FIG. 2 according to an embodiment. The curved display device will hereinafter be described, focusing mainly on structures different from those described with reference to FIG. 3 and avoiding redundant descriptions.

Referring to FIG. 11, a second polarizer 22 may be a wire grid polarizer and may be positioned between the light unit 40 and each of the layers WC1, WC2, and TP.

An insulating layer 221 may be disposed on the planarization layer 220. For example, the insulating layer 221 may be formed of an inorganic insulating material such as silicon oxide.

The second polarizer 22 may include metal wires 22a and a capping layer 22b.

The metal wires 22a may be arranged on the insulating layer 221 along one direction to form a grid pattern. In a case in which incident light passes through the second polarizer 22, the incident light may be polarized in such a manner that components of the incident light that are parallel to the metal wires 22a may be absorbed or reflected by the polarizer 22 and components of the incident light that are perpendicular to the metal wires 22a may be transmitted through the polarizer 22. As the distance among the metal wires 22a increases, the incident light may be more effectively polarized. For example, the metal wires 22a may comprise a metal such as Al, Ag, gold (Au), copper (Cu), or nickel (Ni). For example, the metal wires 22a may be formed by nano-imprinting.

The capping layer 22b may be disposed on the metal wires 22a. The capping layer 22b may inhibit corrosion of the metal wires 22a.

Although example embodiments and implementations have been described, other embodiments and modifications will be apparent from this description. Embodiments are not limited to the example embodiments, but are defined by the scope of the presented claims and include various modifications and equivalent arrangements.

What is claimed is:

1. A curved display device, comprising:
a first substrate on which a plurality of scan lines are disposed to extend in a first direction;
a first pixel unit disposed over the scan lines and including first, second and third sub-pixel electrodes, which are adjacent to one another in a second direction that is different from the first direction;
a second substrate facing the first substrate; and
a color conversion layer disposed on the second substrate and including first and second wavelength conversion layers, which overlap with the first and second sub-pixel electrodes, respectively,
wherein
each of the first, second and third sub-pixel electrodes has long sides, which extend in the first direction, and short sides, which extend in the second direction, and
each of the first and second wavelength conversion layers comprises wavelength conversion materials.

2. The curved display device of claim 1, wherein the color conversion layer further includes a transmissive layer, which overlaps with the third sub-pixel electrode and is disposed in the same layer as the first and second wavelength conversion layers.

3. The curved display device of claim 1, wherein the first pixel unit comprises a first sub-pixel, which comprises the first sub-pixel electrode, a second sub-pixel, which comprises the second sub-pixel electrode, a third sub-pixel, which comprises the third sub-pixel electrode, and
wherein at least two of the first, second and third sub-pixel are electrically connected to different scan lines.

4. The curved display device of claim 1, further comprising a backlight unit providing light having a first wavelength range to the first substrate,
the first wavelength conversion layer receives the light having the first wavelength range and converts the received light into light having a second wavelength range, and
the second wavelength conversion layer receives the light having the first wavelength range and converts the received light into light having a third wavelength range.

5. The curved display device of claim 1, wherein the wavelength conversion materials include quantum dots, quantum rods, and/or a phosphor material.

6. The curved display device of claim 5, wherein
the light having the first wavelength range is blue light,
the light having the second wavelength range is red light, and
the light having the third wavelength range is green light.

7. The curved display device of claim 1, further comprising:
a reflective polarizing layer disposed on the color conversion layer,
wherein the reflective polarizing layer includes a plurality of grid patterns.

8. The curved display device of claim 1, further comprising:
a second pixel unit disposed adjacent to the first pixel unit in the second direction and including first, second and third sub-pixel electrodes, which are adjacent to one another in the second direction; and
a plurality of data lines including a first data line, which is disposed at a first side of the first pixel unit, a second data line, which is disposed between a second side of the first pixel unit and a first side of the second pixel unit, and a third data line, which is disposed at a second side of the second pixel unit,
wherein the data lines extend in the second direction.

9. The curved display device of claim 8, wherein
the first and third sub-pixel electrodes are configured to receive from a first data signal from the first data line, and
the fourth and sixth sub-pixel electrodes are configured to receive a second data signal from the second data line.

10. The curved display device of claim 8, wherein
the second sub-pixel electrode is configured to receive the second data signal from the second data line, and
the fifth sub-pixel electrode is configured to receive a third data signal from the third data line.

11. The curved display device of claim 8, wherein the data lines further include a fourth data line, which is disposed between the first side of the first pixel unit and the second data line, and a fifth data line, which is disposed between the first side of the second pixel unit and the third data line.

12. The curved display device of claim 11, wherein
the second sub-pixel electrode is configured to receive a fourth data signal from the fourth data line, and the fifth sub-pixel electrode is configured to receive a fifth data signal from the fifth data line.

13. The curved display device of claim 1, further comprising:
a third pixel unit disposed adjacent to the first pixel unit in the first direction and including a seventh sub-pixel, which comprises a seventh sub-pixel electrode, an eighth sub-pixel, which comprises the eighth sub-pixel electrode and a ninth sub-pixel, which comprises a ninth sub-pixel electrodes, which are adjacent to one another in the first direction,
wherein
the scan lines include first, second and third scan lines, which are adjacent to one another,
the first and seventh sub-pixels are electrically connected to the first scan line,
the second and eighth sub-pixels are electrically connected to the second scan line, and
the third and ninth sub-pixels are electrically connected to the third scan line.

14. The curved display device of claim 1, wherein the first through third sub-pixel are electrically connected to the same scan line.

15. A curved display device, comprising:
a first substrate;
a second substrate facing the first substrate;
a first sub-pixel region including a first sub-pixel electrode, which is disposed on the second substrate, and a first wavelength conversion layer, which is disposed on the first substrate and overlaps with the first sub-pixel electrode;
a second sub-pixel region including a second sub-pixel electrode, which is disposed in the same layer as the first sub-pixel electrode, and a second wavelength conversion layer, which is disposed on the second substrate and overlaps with the second sub-pixel electrode; and
a third sub-pixel region including a third sub-pixel electrode, which is disposed in the same layer as the first sub-pixel electrode, and a transmissive layer, which is disposed on the second substrate and overlaps with the third sub-pixel electrode,
wherein
each of the first, second and third sub-pixel electrodes has long sides, which extend in a first direction, and short sides, which extend in a second direction that intersects the first direction,
the first, second and third sub-pixel electrodes are adjacent to one another in the second direction, and
to each of the first and second wavelength conversion layers comprises wavelength conversion materials.

16. The curved display device of claim 15, wherein the first, second and third sub-pixel regions display different colors.

17. The curved display device of claim 15, wherein the first wavelength conversion layer, the second wavelength conversion layer, and the transmissive layer are disposed in the same layer.

18. The curved display device of claim 15, further comprising:
a plurality of scan lines disposed on the first substrate and extending in the first direction.

19. The curved display device of claim 15, further comprising:
a backlight unit providing light having a first wavelength range to the first substrate,
wherein
the first wavelength conversion layer receives the light having the first wavelength range and converts the received light into light having a second wavelength range, and
the second wavelength conversion layer receives the light having the first wavelength range and converts the received light into light having a third wavelength range.

20. The curved display device of claim 15, further comprising:
a plurality of data lines disposed on the first substrate and extending in the second direction,
wherein at least one of the data lines overlaps with at least one of the first, second and third sub-pixel electrodes.
